(19) United States
(12) Patent Application Publication
(10) Pub. No.: US 2011/0090783 A1
(43) Pub. Date: Apr. 21, 2011

(54) METHOD AND SYSTEM FOR SMART PROTECTION OF ETHERNET VIRTUAL PRIVATE-ROOTED MULTIPOINT SERVICE

(76) Inventor: Feng Huang, Shanghai (CN)

(21) Appl. No.: 12/735,399

(22) PCT Filed: Jan. 14, 2008
(86) PCT No.: PCT/CN2008/000087

§ 371 Date: Jul. 13, 2010

(51) Int. Cl. H04L 12/26

(52) U.S. Cl. 370/217

(57) ABSTRACT

A method and system for smart protection of Ethernet Virtual Private-Rooted Multipoint Service (EVP-RMP) are provided. The method comprises sending data from a head node through a first root node to a plurality of leaf nodes on their respective first paths; switching a leaf node from its first path to a second path connected to a second root node to receive the data from the head node, if the first path of the leaf node is broken; and maintaining the first paths of the other leaf nodes to receive their data from the head node. The method and system provide an effective protection to services of the user with the broken path without interrupting services of other users, so as to obtain enhanced service reliability and flexibility with reduced switch time.

### FIELD OF THE INVENTION

The present invention generally relates to the field of protection switching and, more particularly, the invention relates to a method and system for smart protection of Ethernet Virtual Private-Rooted. Multipoint Service (EVP-RMP).

### BACKGROUND OF THE INVENTION

Protection switching is a fully allocated survivability mechanism. It is fully allocated in the sense that the route and bandwidth of a protection entity is reserved for a selected working entity. Such a redundant connection to the protection entity provides a fast and simple survivability mechanism. In addition, it is easier for a network operator to grasp the status of the network (e.g., active network topology) with the protection switching.

EVP-RMP may support two root User Network Interfaces (UNIs). In this scenario, each leaf UNI can exchange data only with one or more of the root UNIs. As well, the roots can communicate with each other. In such a service, a redundant access to “the root” can also be provided, effectively allowing for enhanced service reliability and flexibility. It should be noted that leaves would always behave as if there is a traditional unicast relationship from a leaf to an active root. There is no interaction among leaves even when they are redundantly attached to other roots, i.e. when they belong to multiple trees.

In an environment of EVP-RMP service, there are two types of effective protection architectures, 1+1 protection architecture and 1:1 protection architecture. FIG. 1 shows schematically protection switching applied in multi-rooted EVP-RMP service of the prior art. In FIG. 1, Root-2 is dedicated to Root-1 (which is a working transport entity) as a protection transport entity. In the 1+1 protection scenario, traffic from a head is copied and fed to both Root-1 and Root-2, and then transmitted simultaneously from Root-1 and Root-2 to n leaves (leaf-1 to leaf-n). At each leaf, a path connected to Root-1 may be selected as a working path on which the traffic is received by the leaf, while a path connected to Root-2 may be selected as a protection path. Of course, a selection between a working path and a protection path can also be made based on other predetermined criteria, such as connection quality. In the 1:1 protection scenario, however, traffic from a head is transported either through Root-1 or through Root-2 to n leaves (leaf-1 to leaf-n). Each leaf receives the traffic on its respective working path through Root-1.

In multi-rooted EVP-RMP service, according to a traditional solution, if one of the connections between one root and a plurality of leaves is broken, for instance, a connection between Root-1 and leaf-1, then all services on Root-1 will be switched to another root (e.g., Root-2). Accordingly, all the connections between Root-1 and other leaves (e.g., leaf-2 to leaf-n) will be interrupted and switched from Root-1 to Root-2, and then all the leaves will get their services from Root-2. In a 1+1 protection scenario, since the head sends services concurrently to both of working and protection roots, each leaf connected to the working root will switch to its respective protection path to receive services when a protection mechanism is started. In a 1:1 protection scenario, the head sends services only to the working root, thus it is needed to provide the corresponding protection root an indication to connect to the head and forward the services to all of the leaves on their respective protection paths when a protection mechanism is started.

There are several disadvantages of the traditional solution for protection switching, for example, if one of the paths between a working root node and a plurality of leaf nodes is broken, all of the plurality of leaf nodes connected to the working root node will be switched from work paths to protection paths. All services of users supported by this working root node will thus be interrupted and more extra switch time may be incurred, which can make service providers as well as users unhappy.

### SUMMARY OF THE INVENTION

The objective of the present invention is to provide an improved method and system for smart protection switching, which can switch a leaf node from its respective broken path to a protection path without interrupting other leaf nodes connected to the same root node, and can reduce the switch time.

In a first aspect of the present invention, there is provided a method for smart protection of EVP-RMP. The method comprises sending data from a head node through a first root node to a plurality of leaf nodes on their respective first paths; switching a leaf node from its first path to a second path connected to a second root node to receive the data from the head node, if the first path of the leaf node is broken; and maintaining the first paths of the other leaf nodes to receive their data from the head node.

In a second aspect of the present invention, there is provided a system for smart protection of EVP-RMP. The system comprises a first root node adapted to send data from a head node to a plurality of leaf nodes on their respective first paths; and a second root node adapted to provide the plurality of leaf nodes with their respective second paths, wherein each of the plurality of leaf nodes is adapted to switch from its respective first path to second path to receive the data from the head node if the first path is broken, with the other leaf nodes receiving their data from the head node on their respective first paths.

In a third aspect of the present invention, there is provided a method for smart protection of EVP-RMP. The method comprises sending data from a head node to a plurality of leaf nodes through a first root node and a second root node concurrently; selecting adaptively a first path between two paths connected respectively to the first root node and the second root node for each of the plurality of leaf nodes based on connection qualities, so as to receive the data from the head node; switching a leaf node from its respective first path to second path to receive the data from the head node, if the first path of the leaf node is broken; and maintaining the first paths of the other leaf nodes to receive their data from the head node.

In a fourth aspect of the present invention, there is provided a system for smart protection of EVP-RMP. The system comprises a first root node adapted to send data from a head node to a plurality of leaf nodes; and a second root node adapted to send the data from the head node to the plurality of leaf nodes, wherein each of the plurality of leaf nodes is adapted to select adaptively a first path between two paths connected respectively to the first root node and the second root node based on connection qualities so as to receive the data from the head node, and switch from its respective first path to second path to receive the data from the head node if the first path is broken, with the other leaf nodes receiving their data from the head node on their respective first paths.

### BRIEF DESCRIPTION OF THE DRAWINGS

The novel features of the invention are set forth in the appended claims. The invention itself, further objectives, and advantages thereof, will be best understood by reference to the following detailed description of the preferred embodiments when read in conjunction with the accompanying drawings, wherein:

FIG. 1 shows schematically protection switching in multi-rooted EVP-RMP service of the prior art;

FIG. 2A shows schematically a 1+1 protection switching in multi-rooted EVP-RMP service in accordance with an embodiment of the present invention;

FIG. 2B shows schematically a 1:1 protection switching in multi-rooted EVP-RMP service in accordance with another embodiment of the present invention;

FIG. 3 is a schematic flow chart diagram illustrating a smart protection mechanism in accordance with an embodiment of the present invention;

FIG. 4A depicts a smart protection mechanism which may be applied in a 1+1 protection scenario in accordance with an embodiment of the present invention; and

FIG. 4B depicts a smart protection mechanism which may be applied in a 1:1 protection scenario in accordance with another embodiment of the present invention.

### DETAILED DESCRIPTION OF THE INVENTION

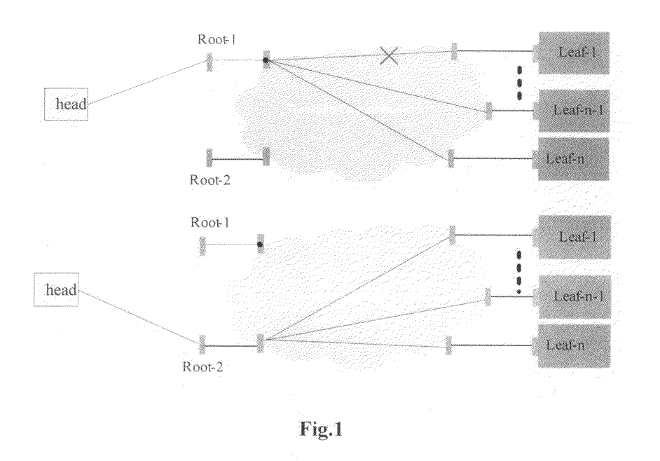

FIG. 1 shows schematically protection switching applied in multi-rooted EVP-RMP service of the prior art, which has been discussed above in connection with the background of the present invention. Reference will now be made in detail to the preferred embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

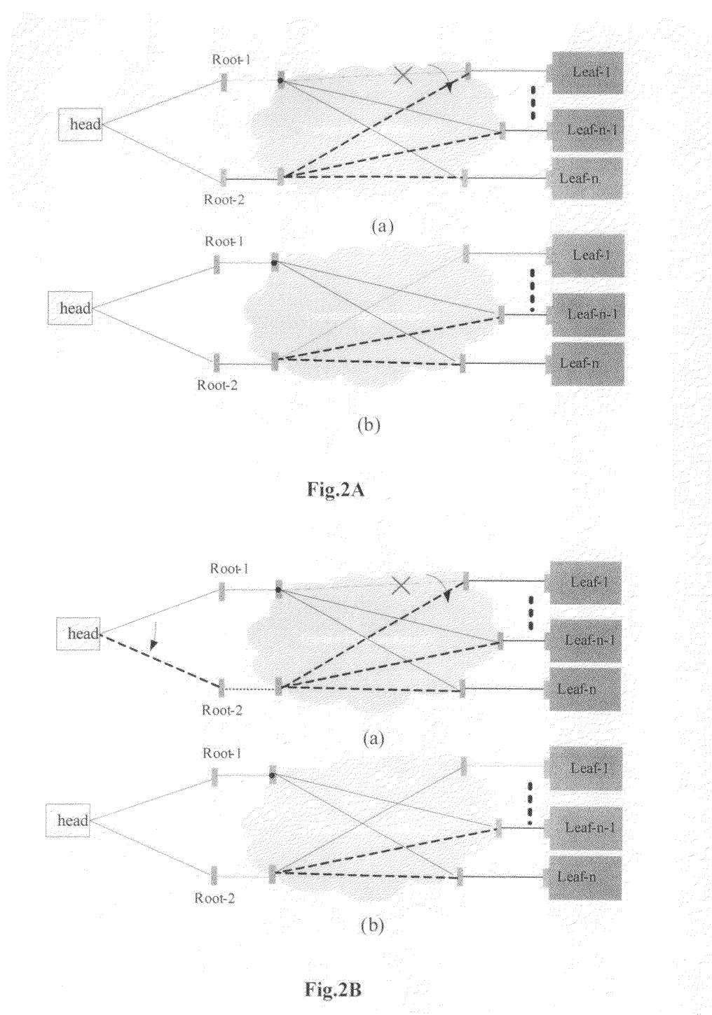

FIG. 2A shows schematically a 1+1 protection switching in multi-rooted EVP-RMP service in accordance with an embodiment of the present invention. A protection switching mechanism may be applied to a domain between two distinct ends, i.e., a head node and a plurality of leaf nodes such as leaf-1 to leaf-n. Between the two ends, there will be both “working” and “protection” transport entities (which are referred to Root-1 and Root-2 respectively in FIG. 2A). When EVP-RMP service is setup, a first connection between Root-1 and each leaf is built, and at the same time, a second connection between Root-2 and each leaf is also built. The head node of the protected signal is capable of performing a bridge function, and in a 1+1 protection scenario, the protected service is permanently bridged to both Root-1 and Root-2. Root-1 and Root-2 send the same services on the first and second paths to the plurality of leaves. Each leaf will perform a selector function, and it is capable of selecting a traffic signal either on its first path or second path. This selection between the first and second paths can be made based on certain predetermined criteria, for example, predefining a working path or choosing the signal adaptively according to connection qualities such as delay and packet loss, etc. In FIG. 2A, traffic data is shown as being received via Root-1 which is specified to provide usual working paths. It should be noted that the smart protection mechanism described herein can also be applicable to the situation of choosing the signal adaptively according to the connection quality.

Protection switching will occur based on a detection of certain defects on the working path within the protected domain. For example, protection switching should be performed when initiated by a specific network management system. If an anomaly such as a broken status of one of the working paths is detected (see part (a) of FIG. 2A), a protection switching process will be informed of this failure condition. As the protection switching process is started, a leaf with a broken working path, such as leaf-1, will switch from its working path to protection path and begin to receive data from Root-2 (see part (b) of FIG. 2A). During this protection switching process, services of other leaves such as leaf-2 to leaf-n will not be interrupted. The other leaves having normal working paths will be maintained to receive data from the head via Root-1. When the protection switching process is completed, the other leaves have both working and protection paths connected to Root-1 and Root-2 respectively, while the leaf with a broken working path only has a protection path connected to Root-2 to obtain the service from the head.

FIG. 2B shows schematically a 1:1 protection switching in multi-rooted EVP-RMP service in accordance with another embodiment of the present invention. Similar to the situation in the 1+1 protection scenario of FIG. 2A, between a head node and a plurality of leaf nodes such as leaf-1 to leaf-n, there will be Root-1 and Root-2 acting as “working” and “protection” transport entities respectively. When EVP-RMP service is setup, a working connection between Root-1 and each leaf is built, and at the same time, a protection connection between Root-2 and each leaf is also built. However, in such 1:1 protection scenario, the protected service is only bridged to Root-1 from the head, which is different from that in the 1+1 protection scenario of FIG. 2A. Root-1 will send the service on working paths to the plurality of leaves, and each leaf will receive its traffic data only on its usual working path.

A determination as to whether a protection switching process will be started can be made based on the checking results of the working paths. For example, if Ethernet OAM (Operation, Administration and Maintenance) detects a broken status of one of the working paths (see part (a) of FIG. 2B) according to a network management system, network elements related to protection switching will receive information about protection, such as protection condition, protection type and etc. via an Automatic Protection Switching (APS) mechanism. Comparing with the 1+1 protection scenario of FIG. 2A, protection switching operations will occur at two distinct ends (i.e. the head and the leaves) in the 1:1 protection scenario. The APS specific information gives the head an indication to switch to Root-2, and then Root-2 begins to forward the corresponding traffic data to the leaf with a broken working path, such as leaf-1. Accordingly, leaf-1 will switch from its respective working path to a protection path to receive data from Root-2. FIG. 2B also illustrates a situation where the protection switching has occurred (see part (b) of FIG. 2B), due to a failure condition on one of the working paths. During this protection switching process, services of other leaves such as leaf-2 to leaf-n will not be interrupted. The other leaves having normal working paths will be maintained to receive data from the head via Root-1.

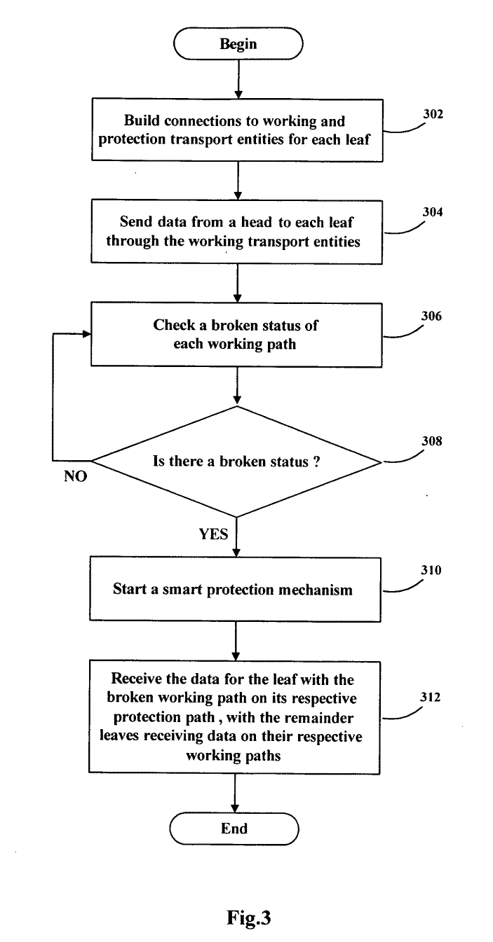

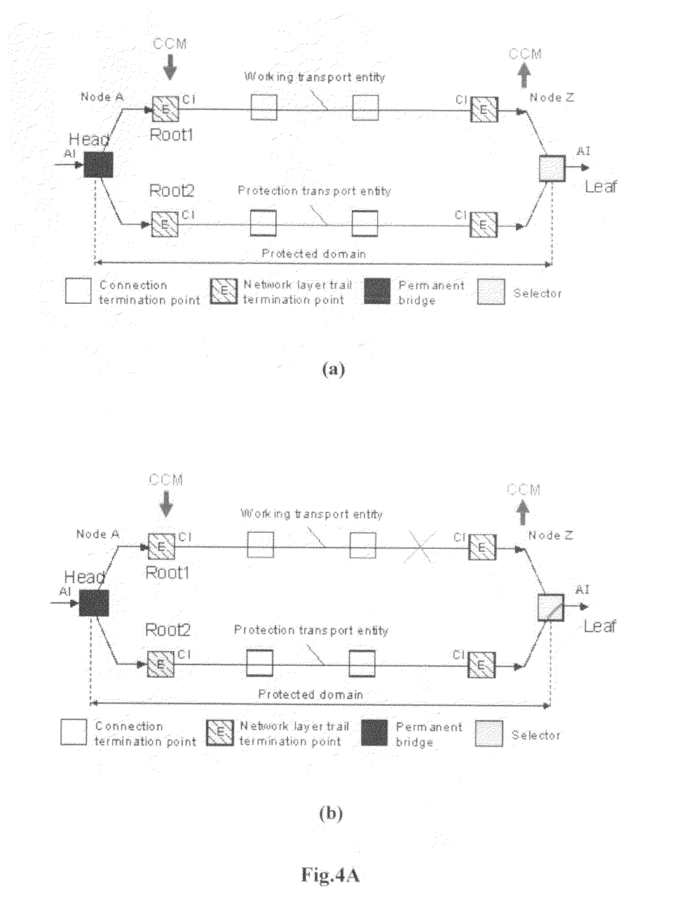

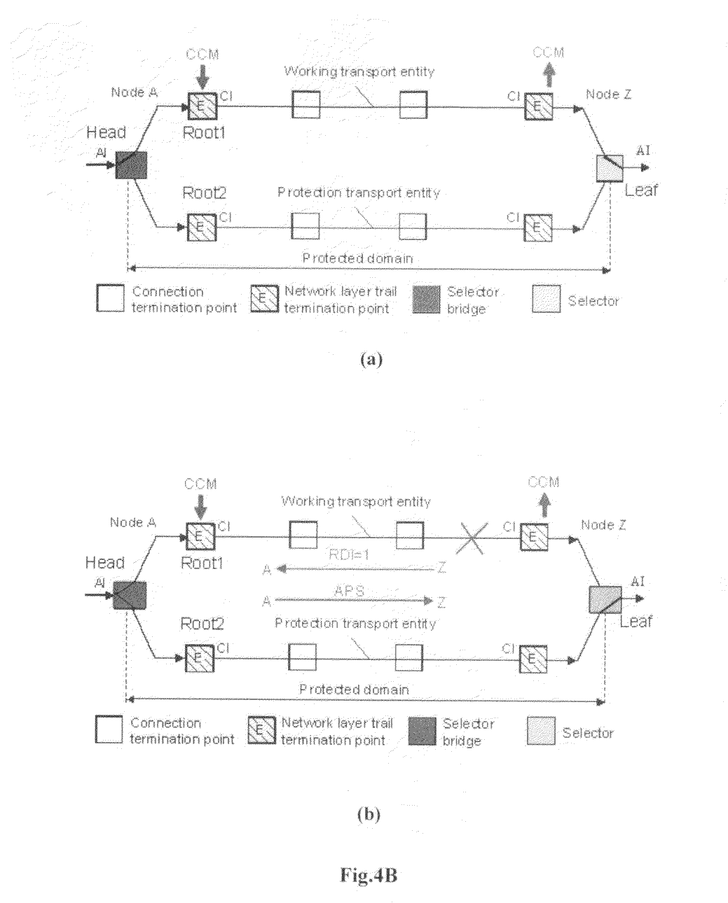

Reference is now made to FIG. 3, which is a schematic flow chart diagram illustrating a smart protection mechanism in accordance with an embodiment of the present invention. In order to support EVP-RMP service and enhance service reliability and flexibility, working and protection transport entities are employed within a protected domain. In step 302, for each leaf, connections to the working and protection transport entities are built respectively. In step 304, services from a head are sent to each leaf through its respective working path. FIG. 4A depicts such smart protection mechanism applied in a 1+1 protection scenario in accordance with an embodiment of the present invention. For clarity, only connections between the head and one of the leaves are shown to illustrate the proposed smart protection approach in details. Referring to part (a) of FIG. 4A, the protected traffic is copied and fed to both working and protection transport entities (i.e. Root1 and Root2) with a permanent bridge between a source (i.e. head) of a protected domain and the working and protection transport entities. Thus, when the traffic is transmitted through the working transport entity, it is also transmitted concurrently through the protection transport entity to a sink (i.e. leaf) of the protected domain, where a selection between traffics from the working and protection transport entities is made by controlling a selector at the sink of the protected domain based on certain predetermined criteria as mentioned before. FIG. 4B depicts a smart protection mechanism applied in a 1:1 protection scenario in accordance with another embodiment of the present invention. Comparing with the 1+1 protection scenario, in the 1:1 protection scenario, the bridge between the head and the working and protection transport entities is not a permanent one but has a selector function. To perform step 304 of FIG. 3, this selector bridge is connected to the working transport entity at service setup, while the selector at the leaf switches to the working path so that the leaf can receive the traffic through the working transport entity (see part (a) of FIG. 4B).

Turning to FIG. 3, in step 306, a status of a working path is checked to determine whether a protection switching process should be performed. In an embodiment, a Continuity Check Message (CCM) with multicast address is sent from Root1 to each leaf to monitor a connection condition of the working path. In step 308, if the CCM has not been received by a corresponding leaf on its working path within a predetermined period, which means the working path is broken, then the method proceeds to step 310 at which the smart protection mechanism is started, otherwise the method turns to step 306.

Referring to part (b) of FIG. 4A, it illustrates a 1+1 protection situation where the protection switching has occurred, due to the broken of the working path. At the head, the traffic will be forwarded to the protection transport entity. At the leaf, the traffic is received from the protection transport entity with the selector switching to the protection path. Referring to part (b) of FIG. 4B, it illustrates a 1:1 protection situation where the protection switching has occurred, due to the broken of the working path. In response to the broken, the leaf will send a Remote Defect Indication (RDI) including its own address back to Root1. Upon receiving the RDI with an indication of the broken, for example, RDI=1, Root1 provides Root2 with an indication to forward the traffic on the protection path of the leaf with the selector bridge connecting to the protection transport entity, while the selector bridge will keep connection to the working transport entity. Then the leaf with the working path will switch to its respective protection path with an indication of APS information.

Turning back to FIG. 3, in step 312, the leaf with the broken working path begins to receive data on its respective protection path, while the other leaves still receive data from their respective working paths. Thus an anomaly of the path between a root and one of the leaves will not interrupt other leaves, and only the broken path will be switched and the switch time can be reduced, e.g. less then 50 ms.

The schematic flow chart diagrams described herein are generally set forth as logical flow chart diagrams. As such, the depicted order and labeled steps are indicative of specific embodiments of the presented method. Other steps and methods may be conceived that are equivalent in function, logic, or effect to one or more steps, or portions thereof, of the illustrated method. The format and symbols employed are provided to explain the logical steps of the method and are understood not to limit the scope of the method. Additionally, the order in which a particular method proceeds may or may not strictly adhere to the order of the corresponding steps shown.

While a leaf with a broken working path receives data on its respective protection path, such working path can be monitored by the CCM, and a revertive operation can be permitted according to a specific network management system. In a non-revertive mode of operation, traffic is allowed to remain on the protection path even after a reason for protection switching has been cleared (e.g., a failure for the working path has occurred and the subsequent repair has been completed). In another embodiment according to the present invention, however, a revertive mode of operation is permitted, thus traffic can be restored to the working path after a reason for protection switching has been cleared. The detailed operational procedure is similar to the protection switching process shown in FIG. 2A to FIG. 4B, and the corresponding descriptions are not repeated here. The described features, structures, or characteristics of the invention may be combined in any suitable manner in one or more embodiments.

The foregoing descriptions of the specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for smart protection of Ethernet Virtual Private-Rooted Multipoint Service, comprising the steps of:
sending data from a head node through a first root node to a plurality of leaf nodes on their respective first paths;
switching a leaf node from its first path to a second path connected to a second root node to receive the data from the head node when the first path of the leaf node is broken; and
maintaining the first paths of the other leaf nodes to receive their data from the head node.

2. The method according to claim 1, wherein a broken status of the first path of the leaf node is checked by a network management system, and wherein the broken status of the first path of the leaf node is ascertained when a continuity check message on the first path has not been received by the leaf node within a predetermined period.

3. The method according to claim 1, wherein the sending the data step further comprises the step of sending the data through the second root node to the plurality of leaf nodes on their respective second paths.

4. The method according to claim 1, wherein the switching step is executed by an automatic protection switching mechanism comprising an indication that the second root node is operable to send the data on the second path of the leaf node.

5. The method according to claim 4, wherein the switching step is executed by the automatic protection switching mechanism further comprises the steps of:
sending, from the leaf node, a remote defect indication that includes an address of the leaf node to the first root node in response to the broken status; and
forwarding the data to the leaf node on the second path by the second root node in response to the remote defect indication.

6. The method according to claim 5, further comprising the steps of:
keeping a connection from the head node to the first root node for the leaf node, and
switching the leaf node from its respective second path to the first path to receive the data in response to an indication that the first path is restored.

7. A system for smart protection of Ethernet Virtual Private-Rooted Multipoint Service, comprising:
a first root node operable to send data from a head node to a plurality of leaf nodes on their respective first paths; and
a second root node operable to provide the plurality of leaf nodes with their respective second paths;
wherein each of the plurality of leaf nodes is operable to switch from its respective first path to second path to receive the data from the head node when the first path is broken, with the other leaf nodes receiving their data from the head node on their respective first paths.

8. The system according to claim 7, further comprising a network management system operable to check a broken status of the first path, wherein the broken status of the first path is ascertained when a continuity check message on the first path has not been received by a respective leaf node within a predetermined period.

9. The system according to claim 7, wherein the second root node is operable to send the data from the head node to the plurality of leaf nodes on their respective second paths.

10. The system according to claim 7, further comprising an automatic protection switching mechanism operable to provide the second root node with an indication to send the data on the second path of the leaf node with the broken first path.

11. The system according to claim 10, wherein the automatic protection switching mechanism is operable to:
send, from the leaf node, a remote defect indication that includes an address of the leaf node to the first root node in response to the broken status; and
forward the data through the second root node to the leaf node on its respective second path in response to the remote defect indication.

12. The system according to claim 7, wherein the first root node is operable to keep a connection to the head node for the leaf node with the broken first path, and wherein each of the plurality of leaf nodes is further operable to switch from its respective second path to first path to receive the data in response to an indication that the first path is restored.

13. A method for smart protection of Ethernet Virtual Private-Rooted Multipoint Service, comprising the steps of:
sending data from a head node to a plurality of leaf nodes through a first root node and a second root node concurrently;
selecting adaptively a first path between two paths connected respectively to the first root node and the second root node for each of the plurality of leaf nodes based on connection qualities to receive the data from the head node;
switching a leaf node from its respective first path to second path to receive the data from the head node when the first path of the leaf node is broken; and
maintaining the first paths of the other leaf nodes to receive their data from the head node.

14. A system for smart protection of Ethernet Virtual Private-Rooted Multipoint Service, comprising:
a first root node operable to send data from a head node to a plurality of leaf nodes; and
a second root node operable to send the data from the head node to the plurality of leaf nodes;
wherein each of the plurality of leaf nodes is operable to:
select adaptively a first path between two paths connected respectively to the first root node and the second root node based on connection qualities to receive the data from the head node; and
switch from its respective first path to second path to receive the data from the head node when the first path is broken, with the other leaf nodes receiving their data from the head node on their respective first paths.

15.-18. (canceled)
